(19) United States
(12) Patent Application Publication
(10) Pub. No.: US 2026/0349930 A1
(43) Pub. Date: Nov. 5, 2026

(54) MULTI-HUMAN-MACHINE INTERFACE SYSTEM AND RESOURCE SHARING METHOD OF MULTIPLE HUMAN-MACHINE INTERFACES

(71) Applicant: DELTA ELECTRONICS, INC., Taoyuan City (TW)

(72) Inventor: Chun-Fu LAI, Taoyuan City (TW)

(21) Appl. No.: 19/281,489

(22) Filed: Jul. 25, 2025

(30) Foreign Application Priority Data
Apr. 30, 2025 (CN) 2025105664011

(51) Int. Cl. G06F 12/1036; G06F 9/455; G06F 12/1081

(52) U.S. Cl. CPC G06F 12/1036; G06F 9/45508; G06F 12/1081; G06F 2212/152

(57) ABSTRACT

A multi-human-machine interface system includes a plurality of human-machine interfaces and a computation device. The plurality of human-machine interfaces includes a first human-machine interface and a second human-machine interface. The computation device is connected to the first human-machine interface and a second human-machine interface and executes an editing software to set a virtual shared memory block of the first human-machine interface and a second human-machine interface; where the first human-machine interface and a second human-machine interface use the virtual shared memory block to utilize, synchronize, and update shared resources.

### TECHNICAL FIELD

The present disclosure relates to a human-machine interface and a method adapted by the human-machine interface, and particularly to a multi-human-machine interface system and resource sharing method of multiple human-machine interfaces.

### RELATED ART

Human-machine interface (HMI) serves as a communication interface between users and machine devices, allowing the users to intuitively manage or monitor the operation of the machine devices. An HMI can establish connections with other HMIs and different operating devices through multiple communication protocols, enabling the users to simultaneously manage and monitor the operating status of multiple devices through HMI. For HMIs communication normally, the users need to manually complete the connection settings for all device (including settings for other HMIs and the operating devices) on each HMI in advance before operating the devices. Since HMI configurations are fixed once set, if the devices need to be moved or replaced, the users also need to manually change the settings for all related devices one-by-one. However, this approach is time-consuming, and as the system architecture becomes larger, the number of devices requiring reconfiguration increases and the connection relationships become more complex, making manual setting errors more likely to occur.

As mentioned above, the existing mechanism for maintaining the system environment of HMI devices lacks flexibility and wastes user’s time and effort on manual maintenance. Accordingly, how to overcome the problem of overly rigid HMI configuration mechanisms is a concern for those skilled in the art.

### SUMMARY OF THE DISCLOSURE

The object of the present disclosure is to provide a multi-human-machine interface system and a resource sharing method of multiple human-machine interfaces, which can solve the problem that the existing system environment lacks flexibility on adjustment.

In one of the exemplary embodiments, the multi-human-machine interface system includes multiple human-machine interfaces and a computation device. The multiple human-machine interfaces include a first human-machine interface and a second human-machine interface. The computation device is coupled with the first human-machine interface and the second human-machine interface, and is configured to execute an editing software to set a shared memory block of the first human-machine interface and the second human-machine interface; wherein the editing software is configured to perform a memory sharing operation for the first human-machine interface and the second human-machine interface through the shared memory block, and the shared memory block is configured with a virtual address space respectively mapped to a first memory of the first human-machine interface and a second memory of the second human-machine interface. The first human-machine interface is configured to access the first memory or the second memory being mapped to the virtual address space through the shared memory block, and the second human-machine interface is configured to access the first memory or the second memory being mapped to the virtual address space through the shared memory block.

In one of the exemplary embodiments, the multi-human-machine interface system of the present disclosure include multiple human-machine interfaces and a computation device. The multiple human-machine interfaces include a first human-machine interface that is connected with a first operating device and a second human-machine interface that is connected with a second operating device. The computation device is coupled with the first human-machine interface and the second human-machine interface and is configured to execute an editing software to set a common device resource of the first human-machine interface and the second human-machine interface; wherein the common device resource is configured to include a memory space of the first operating device recording first operating device data and a memory space of the second operating device recording second operating device data. The first human-machine interface accesses the first operating device data through the first operating device, and access the second operating device data through the common device resource; the second human-machine interface accesses the second operating device data through the second operating device, and access the first operating device data through the common device resource.

In one of the exemplary embodiments, the resource sharing method of multiple human-machine interfaces of the present disclosure is provided, wherein the multiple human-machine interfaces include a first human-machine interface and a second human-machine interface, and the first human-machine interface and the second human-machine interface are respectively coupled with a computation device. The resource sharing method includes: executing an editing software by the computation device to set a virtual shared memory block of the first human-machine interface and the second human-machine interface; and, using the virtual shared memory block by the first human-machine interface and the second human-machine interface to utilize, synchronize, and update shared resources.

### BRIEF DESCRIPTION OF THE DRAWINGS

FIG. 1 is a block diagram of an editing software and a shared configuration of the human-machine interface of an embodiment according to the present disclosure.

FIG. 2 is a schematic diagram showing multiple human-machine interfaces using the virtual shared memory block according to the present disclosure.

FIG. 3 is a flowchart of operating the editing software of the resource sharing method of an embodiment according to the present disclosure.

FIG. 4 is a flowchart of the broadcast updating procedure of the resource sharing method of an embodiment according to the present disclosure.

FIG. 5 is a flowchart of switching new owner human-machine interface of the resource sharing method of an embodiment according to the present disclosure.

### DETAILED DESCRIPTION OF THE DISCLOSURE

In cooperation with the attached drawings, the technical contents and detailed description of the present disclosure are described hereinafter according to multiple embodiments, being not used to limit its executing scope. Any equivalent variation and modification made according to appended claims is all covered by the claims claimed by the present disclosure.

The terms such as “first”, “second”, and “third” used in the present disclosure are used to describe different components, elements, areas, layers, and/or parts, and these components, elements, areas, layers, and/or parts are not restricted by these terms. These terms are only used to differ one component, element, area, layer or part from another. Unless the context clearly makes a definition, otherwise the terms such as “first”, “second”, and “third” used in the description do not imply the order or the sequence.

To solve the problem of overly rigid physical connections among human-machine interfaces and between human-machine interfaces and operating devices in terms of operation, every human-machine interface in the multi-human-machine interface system of the present disclosure uses a resource sharing mechanism. Even if the human-machine interfaces or the operating devices are changed physically to other connection relationships, once the multiple human-machine interfaces belong to same group (i.e., a resource sharing group), they can obtain, through the resource sharing mechanism, related resources of the devices not connected therewith without waiting for the user to manually modify the system configurations or identify other human-machine interfaces or operating devices by themselves. Therefore, an effect of dynamically managing the human-machine interfaces can be achieved.

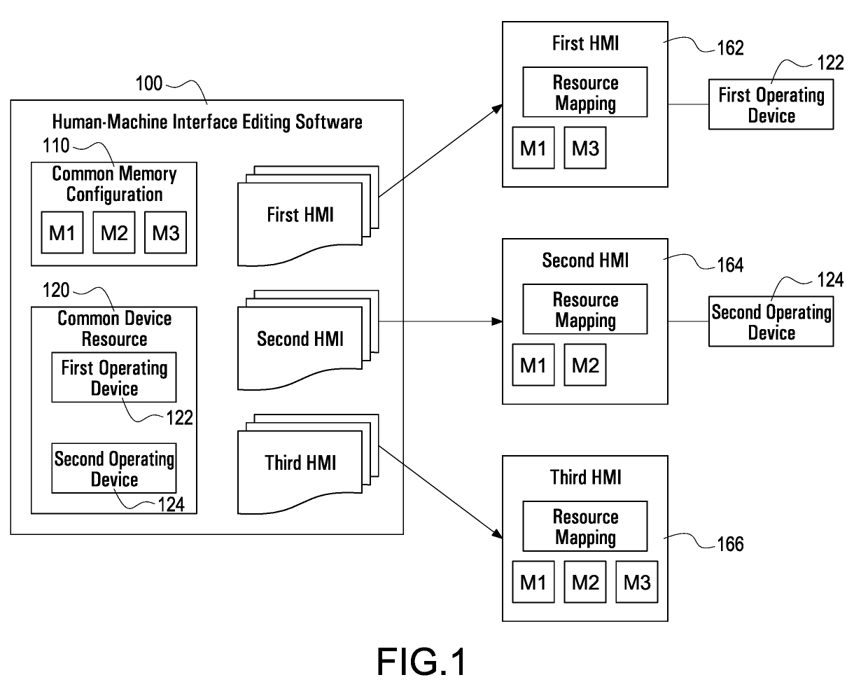

FIG. 1 is a block diagram of an editing software and a shared configuration of the human-machine interface of an embodiment according to the present disclosure. A human-machine editing software 100 (referred to as the editing software hereinafter) is installed in a computation device (not shown). The computation device executes the editing software 100, opens one project to set the shared configuration for a human-machine interface under the editing software 100, so different human-machine interfaces are configured through different projects (i.e., every project is a small project corresponding to one human-machine interface). In another embodiment, the computation device opens a project that covers many small projects (i.e., a large project includes multiple configurations for multiple human-machine interfaces of multiple small projects). In another embodiment, the computation device opens a project respectively recording the configurations of multiple human-machine interfaces (i.e., a large project), and sets group information in the project to configure the multiple human-machine interfaces to be in same group. In another embodiment, the computation device adds a group setting to multiple completely edited projects to enable the editing software 100 to know that these projects belong to same group (i.e., the multiple human-machine interfaces in these projects belong to same group), and respectively sets the common configuration of the multiple human-machine interfaces in these projects.

The computation device can be a computer, the common configuration can include a common memory configuration 110 and a common device resource configuration 120 (i.e., tags of the operating devices, communication setting information of connection devices, and categories and ranges of the registers, etc., wherein the tags can be device identification data or I/O control).

The common memory configuration 110 includes a first memory block M1, a second memory block M2, and a third memory block M3. For example, the first memory block M1 is a shared memory block provided by a first human-machine interface 162 (for example, is a shared memory block of the first human-machine interface 162, a second human-machine interface 164, and a third human-machine interface 166); the second memory block M2 is a shared memory block provided by the second human-machine interface 164 (for example, is a shared memory block of the second human-machine interface 164 and the third human-machine interface 166); the third memory block M3 is a shared memory block provided by the third human-machine interface 166 (for example, is a shared memory block of the first human-machine interface 162 and the third human-machine interface 166). In another embodiment, the common memory configuration 110 may cover a memory from an external storage device, the present disclosure does not restrict the source of the shared memory. In one of the exemplary embodiments, the memory block can be physical memory, flash memory, or logical file space from each human-machine interface, but is not limited thereto.

In particularly, the computation device of the present disclosure executes the editing software 100 to set the shared memory block of each human-machine interface that participated the sharing (such as the aforementioned first to third memory blocks M1~M3 of the first to third human-machine interfaces 162, 164, 166), and the editing software 100 performs memory sharing operation of each human-machine interface through these shared memory blocks. In the present disclosure, the shared memory blocks are configured with virtual address spaces which are respectively mapped to the memories of each of the human-machine interfaces participated to the sharing.

The editing software 100 is a common software which can access screen design information of different human-machine interfaces. For example, the editing software 100 can access and edit the screen design information and the common configuration of the first human-machine interface 162, the second human-machine interface 164, and the third human-machine interface 166.

The editing software 100 can edit and change variables of the human-machine interfaces. The variables include data of the human-machine interfaces, which may be system parameters, memory variables, configuration settings, and screen and component settings, etc.

After completing the common configuration made to each human-machine interface, the editing software 100 respectively downloads the common configuration to each corresponding human-machine interface, thus enabling each human-machine interface to operate according to the system parameters, memory variables, configuration settings, and screen and component settings of the common configuration.

The multi-human-machine interface system includes multiple human-machine interfaces that can optionally communicate with each other (depending on the physical configuration, the present disclosure does not restrict the connection topology of the multiple human-machine interfaces), wherein, the multiple human-machine interfaces indicate two or more than two human-machine interfaces.

The multi-human-machine interface system sets up the virtual shared memory block to resolve the problem of a lack of flexibility in existing system environments for maintaining HMI devices.

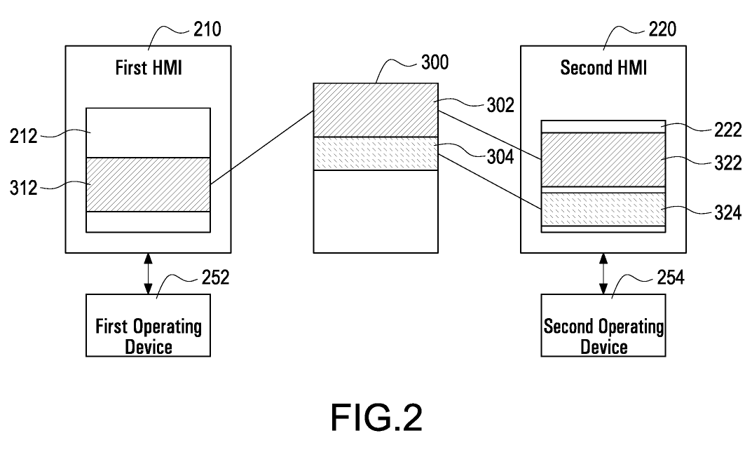

FIG. 2 is a schematic diagram showing multiple human-machine interfaces using the virtual shared memory block according to the present disclosure.

The first human-machine interface 210 and the second human-machine interface 220 use the virtual shared memory block 300 to implement the flexible configuration of the human-machine interfaces and the operating devices.

The virtual shared memory block 300 includes at least one shared block. In this embodiment, two shared blocks 302, 304 are taken as an example. According to a resource mapping relationship, each shared block of the virtual shared memory block 300 will be mapped to a corresponding storage block. Each shared block has an owner at a time, where the owner has the authority of changing and managing this shared block. For example, the owner of the shared block 302 is the first human-machine interface 210 and the shared block 302 is shared by the first human-machine interface 210 and the second human-machine interface 220. The owner of the shared block 304 is the second human-machine interface 220 and the shared block 304 is only used by the second human-machine interface 220 without being shared with the first human-machine interface 210.

In particularly, all the human-machine interface belonging to same group and participated the sharing has an internal memory block that having a mapped relationship with the virtual shared memory block 300 (which is a virtual space). The term “mapped” mentioned above indicates that when any human-machine interface changes the content of this virtual space, this change will be synchronized to the human-machine interface(s) that participated the sharing. On the other hand, the activity that each human-machine interface reads its own shared memory block belonging to local activity, which will not change the content of the virtual shared memory block 300. It should be mentioned that, in the present disclosure, the content of every shared block is subject to its owner, and the owner can decide whether to change the content of this shared block and perform synchronization behavior, while the owner’s own memory block provides local access to the owner; other human-machine interface other than the owner can passively accept the content of synchronization or can provide a request for the synchronization to the owner, in this manner, each human-machine interface’s memory block is used as a cache for each human-machine interface.

The owner having the authority of changing and managing the virtual shared memory block 300 indicates that only the owner can agree or deny when a human-machine interface utilizes, synchronizes, and updates the shared resources. For example, when the second human-machine interface 220 wants to update a resource to the shared block 302, due to the first human-machine interface 210 to be the owner, the second human-machine interface 220 needs to obtain the consent of the first human-machine interface 210 to write or synchronize the resource to the shared block 302. For example, the second human-machine interface 220 can provide a writing request to the first human-machine interface 210, and the first human-machine interface 210 directly performs a group update (i.e., the first human-machine interface 210 updates the shared block 302 and then other human-machine interfaces perform synchronization). For another example, the second human-machine interface 220 can provide a writing request to the first human-machine interface 210, and then after the first human-machine interface 210 replies to the second human-machine interface 220, the second human-machine interface 220 updates an internal memory (such as the storing block 322 as shown in FIG. 2) corresponding to the shared block 302 after confirmation, and then the first human-machine interface 210 performs group update at a suitable time point based on an updating rule (i.e., the first human-machine interface 210 updates the shared block 302, and then other human-machine interfaces other than the second human-machine interface 220 performs synchronization).

In one of the exemplary embodiments, the editing software 100 is used to edit a group project to generate an execution program, script, or setting data, and to deploy the execution program, script, or setting data to the group members of the multiple human-machine interface. The group members operate the execution program, script, or setting data, and execute, under the runtime environment, procedures such as data access backup to the virtual shared memory block 30 and write updated data to the virtual shared memory block 300 and request broadcast updates, etc.

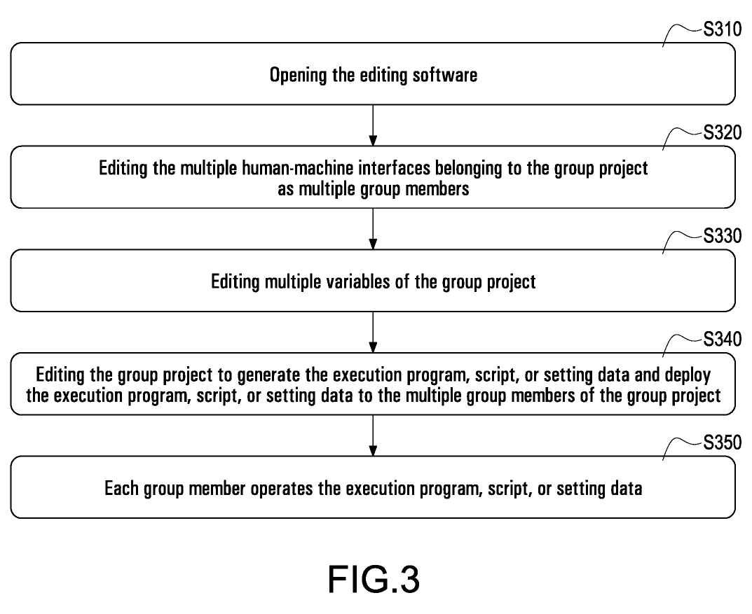

FIG. 3 is a flowchart of operating the editing software of the resource sharing method of an embodiment according to the present disclosure. For the ease of understanding, the following description takes the operation of the editing software shown in FIG. 1 for interpretation.

In step S310, opening the editing software by the computation device.

In one of the exemplary embodiments, the editing software may be a tool used to edit device communication protocols, write data configurations, or control operation commands, which is used to operate and control the human-machine interfaces.

In step S320, editing the multiple human-machine interfaces belonging to the group project as multiple group members through the editing software.

In one of the exemplary embodiments, the editing software may edit one or more resource shared groups (referred to as the groups hereinafter), each group includes multiple group members (i.e., human-machine interfaces). Every group uses same group project, and all the group members in same group can only access the shared resource of the human-machine interfaces belonging to the same group.

In step S330, editing multiple variables of the group project through the editing software.

In one of the exemplary embodiments, the variables include at least one of system parameters, memory addresses, connection settings with all of the human-machine interfaces, screen parameters of the human-machine interface, and all the human-machine interface’s tags of the human-machine interface itself.

In another embodiment, information of the operating device is included in the variables. In the meantime, the editing software 100 edits the protocol configuration and the channel configuration between the multiple operating devices and the multiple human-machine interfaces, as well as information of the registers of the multiple operating devices. These variables can be used to generate the common device resource 120.

In one of the exemplary embodiments, the variables of the group project are static variables, such as being used to indicate the connection between each human-machine interface and each device.

In step S340, editing the group project to set the shared resource (including multiple variables, shared memory blocks, and common device resources, etc.) and respectively configure the shared resource to each individual group member, and generate the execution program, script, or setting data and deploy the execution program, script, or setting data to the multiple group members of the group project, through the editing software 100.

In one of the exemplary embodiments, each group member can be respectively configured with usable shared resource, for the sake of following shared operations among the group members. Each group member, in addition to knowing the operation setting and the connection configuration of the operating devices connected with itself, also knows other operating devices that are not connected therewith as well as variable information related to these operating devices (without knowing which operating device is connected with which group member) based on the group project. When one human-machine interface wants to obtain the device information of an operating device not connected with itself, this human-machine interface can obtain the operating setting and the connection configuration of this operating device from other group members of the group through the shared resource.

In step S350, each group member uses the shared resource configuration and private resource to execute each individual configuring operation and operates the execution program, script, or setting data to execute under a runtime environment.

In one of the exemplary embodiments, each group member executes a fixed execution program, it has fixed reference information under the runtime environment. If the user wants to add information that is not included in the group project, the step S310 to the step S330 are required to be re-executed to edit the group project, and the step S340 to the step S350 are required to be re-executed to deploy the edited information to the group members. Therefore, the effect of group deployment of human-machine interfaces can also be achieved.

For example, the first human-machine interface 210 is connected to a first operating device 252 (such as a PLC), and the common information stored in the shared block 302 includes variable information of the first operating device 252. When the procedure of the first operating device 252 is updated and few variable information is added, the user may update the variable information of the first operating device 252 in the group project through the aforementioned steps, and then deploy the updated information to the group members, thus performing update to all the group members. For another embodiment, if it is desired to perform display and control only through the second human-machine interface 220 that is not directly connected to the first operating device 252, then after the user updates the variable information of the first operating device 252 in the group project through the aforementioned steps, the changed information can be added only to the page of the second human-machine interface 220 for redownload to the second human-machine interface 220. In this embodiment, other human-machine interface (including the first human-machine interface 210 connected with the first operating device 252) shouldn’t do any change during the procedure, therefore only the group member(s) being affected should be updated.

It should be mentioned that the editing made by the editing software to the group project of the human-machine interfaces belongs to static changing, and the content that is editable by the editing software is static shared data. On the other hand, the human-machine interface is deployed with the execution program that is executed under the runtime environment, the content shared among the multiple human-machine interfaces belongs to dynamic shared resource. For example, the change to the resource stored in the third memory block M3 of the third human-machine interface 166 belongs to dynamic changing.

In one of the exemplary embodiments, the execution program can provide an operating interface in the runtime environment, where the operating interface includes connection port information of each human-machine interface. The user can adjust, on the operating interface, the connection port information of the human-machine interface correspondingly based on the physical connection relationship.

Please refer back to FIG. 2. In one of the exemplary embodiments, each human-machine interface can be coupled with other human-machine interface(s) and/or operating device(s). For example, the first human-machine interface 210 is coupled with the first operating device 252. The second human-machine interface 220 is coupled with the second operating device 254. The operating device can be, for example, a programmable logic controller (PLC), a sensor, a motor, or other industrial control devices.

The first human-machine interface 210 includes a storing block 212. The second human-machine interface 220 includes a storing block 222. The shared block 302 of the virtual shared memory block 300 is mapped to the storing block 312 and the storing block 322, and the shared block 304 of the virtual shared memory block 300 is mapped to the storing block 324. For example, assuming that the internal storing block addresses of the human-machine interface is $0-$19999, the shared block 302 can be defined as 1000 words from $V0-$V999, the first human-machine interface 210 is mapped to addresses $10000-$10999, and the second human-machine interface 220 is mapped to addresses $0-$999. In other words, no matter which project corresponding to which human-machine interface is edited, $V0-$V999 can be used to access this shared block 302.

In one of the exemplary embodiments, each human-machine interface can execute procedures including resource restoring or update to latest data from the shared resource.

Under the runtime environment, the first human-machine interface 210 and the second human-machine interface 220 read the shared resource in the shared block 302 of the virtual shared memory block 300. It should be mentioned that the first human-machine interface 210 and the second human-machine interface 220 are group members of same group project, so they can access the shared resource from the virtual shared memory block 300 through the aforementioned mechanism.

For example, the user wants to operate the second operating device 254 through the first human-machine interface 210. In related arts, because the second operating device 254 is not connected with the first human-machine interface 210, the user cannot obtain any information related to the second operating device 254 from the first human-machine interface 210 and cannot perform operation (for example, cannot display real-time parameter information of the second operating device 254 on the first human-machine interface 210). In the present disclosure, because the first human-machine interface 210 and the second human-machine interface 220 have the group relationship, the second human-machine interface 220 shares the resource of the second operating device 254 that is connected with itself. Therefore, once the second human-machine interface 220 synchronizes the data of the second operating device 254 to the shared block 302 of the virtual shared memory block 300 (such as regular execution data, reads the data from the second operating device 254 and writes to the shared block 302), the first human-machine interface 210 can indirectly obtain the information of the second operating device 254 connected with the second human-machine interface 220 through the second human-machine interface 220 by way of reading the shared resource from the shared block 302 of the virtual shared memory block 300, and the first human-machine interface 210 is not restricted in obtaining information only from the devices directly connected with itself. Therefore, the user can display the real-time parameter information of the second operating device 254 on the first human-machine interface 210 without any additional settings.

In addition to exchanging device information through the virtual shared memory block 300, the present disclosure further performs device information exchange through the common device resource 120. As mentioned above, the editing software of the present disclosure is used to set the common device resource 120 for the multiple human-machine interfaces in the group project. The common device resource 120 includes, for example, tags of the operating devices (such as the first operating device 122 and the second operating device 124), communication setting information, and register information, etc., wherein the tags can be device identification data or I/O control. For example, the second operating device 254 is not connected with the first human-machine interface 210, and the first human-machine interface 210 does not know which human-machine interface is connected with the second operating device 254. However, the first human-machine interface 210 is aware that the second operating device 254 has a first tag (such as CalibChannel1) through the common device resource 120, at the time, the first human-machine interface 210 can send an access request of accessing the first tag of the second operating device 254 to other group members in the same group, and the second human-machine interface 220 (which is connected with the second operating device 254) can assist the first human-machine interface 210 in accessing the first tag of the second operating device 254 after receiving the access request. In this embodiment, the user does not need to obtain device information through memory exchange.

Under some circumstances, the device connected to the first human-machine interface 210 generates information that is not existing in the group project; thus, other human-machine interfaces are not under the situation of having the latest information. The following paragraphs interprets how the first human-machine interface 210 requests the virtual shared memory block 300 to perform broadcast updating procedure to deal with the above circumstance.

Under the runtime environment, the first human-machine interface 210 publishes update data to the shared block 302 of the virtual shared memory block 300. The update data is, for example, the device configuration, the device resource, and the tag address, etc. of the first human-machine interface 210. Next, the first human-machine interface 210 sends out a global notification. In the embodiment, the owner of the shared block 302 is the first human-machine interface 210, so the first human-machine interface 210 has the authority of updating the shared block 302 and can trigger other human-machine interfaces in the same group that are not the owner to perform synchronization to the shared block 302. Therefore, after updating the content of the shared block 302, the first human-machine interface 210 can perform group broadcasting to the group members in the same group based on the global notification to remind the group members to update data, thereby enabling the group members to read the shared block 302 of the virtual shared memory block 300 to obtain the update data.

General speaking, the approach of publishing the update data can be, for example but not limited to: 1. sending a global update request with attached update data; 2. sending the global notification to notify the group members about the update, so as to remind the needed group members to access; 3. combining the 1th and the 2^{nd} approaches above. The 1th approach is adapted when the update data is short data, while the 2^{nd} approach is adapted when the update data is long data, thereby avoiding excessive spam messages.

In the embodiment that a non-owner wants to update the shared memory block, for example, when the second human-machine interface 220 (not the owner of the shared block 302) wants to publish the update data to the memory (such as the storing block 322) mapped to the shared block 302, the second human-machine interface 220 needs to first send the global change request to the owner of the shared block 302 (such as the first human-machine interface 210). To be more specific, the second human-machine interface 220, as a non-owner, can: (1) write the update data to local memory, and then send the change request to the owner of the shared block 302; or (2) send the change request to the owner of the shared block 302 and wait for the update result. If 2^{nd} approach is adapted, conflict issues with synchronization waiting can be reduced. Therefore, the owner of the shared block 302 can change the content of the shared block 302 based on the update data according to the global change request. After the content of the shared block 302 is updated, the owner broadcasts the update data to each group member in the same group through global notification, thereby enabling each group member to store the update data to their local storing block to maintain the synchronization with the shared block 302.

In another embodiment, the first operating device 252 is moved from connecting with the first human-machine interface 210 to connecting with the second human-machine interface 220, i.e., the second human-machine interface 220 is coupled with the first operating device 252 and the second operating device 254. Because the second human-machine interface 220 automatically detects the variation of the connected devices and the shared block 302 already stores the resource related to the first operating device 252, even if the first operating device 252 is moved to connect with the second human-machine interface 220, the second human-machine interface only needs to obtain the resource related to the first operating device 252 from the shared block 302 of the virtual shared memory block 300. Therefore, even if the device connected to any human-machine interface of the group has been changed, every group member can obtain the information of the changed device through the resource shared mechanism as discussed above.

When the first operating device 252 is moved, it no longer connects with the first human-machine interface 210. When the first human-machine interface 210 wants to access data of the first operating device 252, it can also access through using the common device resource 120. More specifically, the first human-machine interface 210 directly sends an access request for data of the first operating device 252 to the group, so that the second human-machine interface 220 currently connected with the first operating device 252 can access data of the first operating device 252 for the first human-machine interface 210. By using this approach, the first human-machine interface 210 can also access data of the first operating device 252 that is no longer connected therewith without using the virtual shared memory block 300. Relatively, the second human-machine interface 220 originally had to access data of the first operating device 252 through the group, but after the first operating device 252 was changed to be connected with the second human-machine interface 220, the second human-machine interface 220 can directly access the first operating device 252 through the connection relationship, without needing to go through the group anymore.

Under some circumstances, the first human-machine interface 210 may be in a bad condition, thereby affecting the data sharing. The following paragraphs are used to interpret the human-machine interface switching procedure being triggered by the first human-machine interface 210 to switch to a new owner to resolve the above condition. It should be mentioned that the first human-machine interface 210 is the owner of the shared block 302, so the switching procedure affects the authority of changing and managing the resource of the shared block 302.

Under the runtime environment, the first human-machine interface 210 broadcasts a switch-over request to multiple human-machine interfaces for the multiple human-machine interfaces to perform the switching procedure through the switch-over request to elect a new owner human-machine interface. In one of the exemplary embodiments, the multiple human-machine interfaces determine the new owner human-machine interface based on a negotiation number of each of the human-machine interfaces.

In one of the exemplary embodiments, the negotiation number is determined by random numbers, pre-determined priority values (e.g., variables set in the group project), and the execution performance of the multiple human-machine interfaces. For example, one of the multiple human-machine interfaces having the smallest negotiation number (i.e., have the largest priority value) will be elected as the new owner human-machine interface. Next, the new owner human-machine interface takes over the management for the shared block of the virtual shared memory block. For example, the new owner human-machine interface is the second human-machine interface 220, so the second human-machine interface 220 takes over the authority of managing the shared block 302 and provides the data in the pre-mapped storing block 322 as the shared resource.

In one of the exemplary embodiments, the shared resource includes device configuration (such as connection port information), device resources (such as current and voltage), and tag address of the group members of the human-machine interfaces.

Since the memory space and type on the multiple human-machine interfaces are determined based on product design rules, they do not change due to switching to a new owner human-machine interface.

Therefore, if the owner human-machine interface encounters an issue such as lower performance, about to be shot down, and abnormal memory management, etc., the switching procedure may be triggered. After switching, the new owner human-machine interface manages the virtual shared memory block 300 to maintain uninterrupted sharing mechanism.

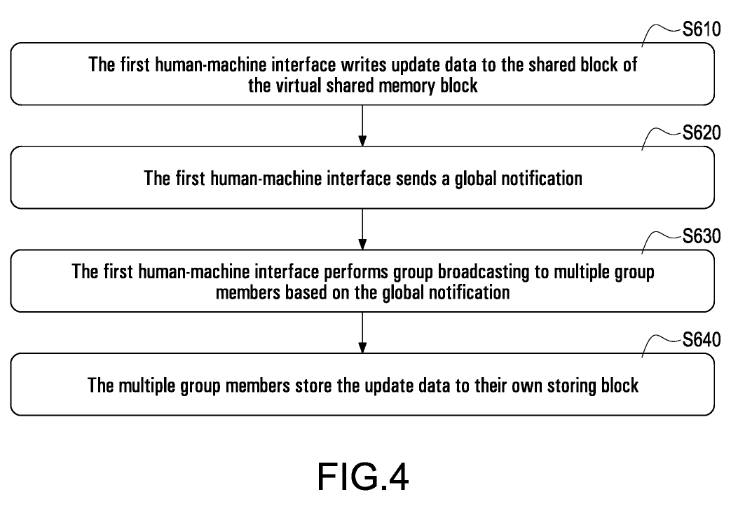

FIG. 4 is a flowchart of the broadcast updating procedure of the resource sharing method of an embodiment according to the present disclosure. The resource sharing method is interpreted below by incorporated with the multi-human-machine interface system as shown in FIG. 2.

In step S610, the first human-machine interface 210 writes update data to the shared block 302 (a first shared block) of the virtual shared memory block 300.

In one of the exemplary embodiments, the first operating device 252 is physically connected with the first human-machine interface 210 but not energized. After the first operating device 252 is energized, the first operating device 252 is regarded as the device currently being operated by the first human-machine interface 210. In the meantime, the first human-machine interface 210 writes the device information (such as connection port information) of the device currently being operated into the shared block 302 of the virtual shared memory block 300. In the embodiment, the first human-machine interface 210 is the owner of the shared block 302.

In step S620, the first human-machine interface 210 sends a global notification.

For example, after the shared block 302 of the virtual shared memory block 300 is written with new data, the first human-machine interface 210 sends the global notification, thus other human-machine interfaces may perform synchronized status updates. It should be mentioned that, if the first human-machine interface 210 is not the owner of the shared block 302, the first human-machine interface 210 needs to send a global change request to the owner of the shared block 302 to update the content of the shared block 302.

In step S630, the first human-machine interface 210 performs group broadcasting to multiple group members based on the global notification to remine the group members of data update.

In one of the exemplary embodiments, the first human-machine interface 210 broadcasts the update data, so every group member can obtain the update data. For example, the second human-machine interface 220 obtains the device information of the device currently being operated by the first human-machine interface 210.

In step S640, the multiple group members store the update data into their own storing block.

For example, the second human-machine interface 220 stores the device information of the device currently being operated by the first human-machine interface 210 into storing block 322 (a second storing block). In one embodiment, data in the storing block 322 is identical to data in the storing block 312.

Therefore, even if the device information of the device currently being operated changes, group members can obtain the latest information based on the broadcast updating procedure, without relying on a direct connection to the human-machine interface and without waiting for the user to manually make changes.

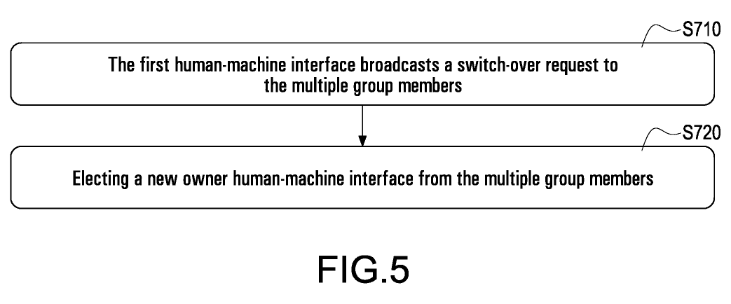

FIG. 5 is a flowchart of switching new owner human-machine interface of the resource sharing method of an embodiment according to the present disclosure. The resource sharing method is interpreted below by incorporated with the multi-human-machine system as shown in FIG. 2.

In step S710, the first human-machine interface 210 (i.e., the owner of the shared block 302 of the virtual shared memory block 300) broadcasts a switch-over request to multiple group members.

The first human-machine interface 210 has the authority of changing and managing the shared block 302. Every human-machine interface in the same group project can be elected as a new owner human-machine interface. In this embodiment, the first human-machine interface 210 broadcasts the switch-over request to the second human-machine interface 220.

In one embodiment, all of the human-machine interface in the same group project can determine who should be the new owner human-machine interface through their own negotiation number. For example, the human-machine interface having the smallest negotiation number (i.e., the largest priority value) will be elected as the new owner human-machine interface, such as the second human-machine interface 220 will be elected as the new owner human-machine interface.

In step S720, a new owner human-machine interface is elected from the multiple group members.

For example, the second human-machine interface 220 is elected as the new owner human-machine interface. In the meantime, the second human-machine interface 220 takes over the authority of changing and managing the shared block 302 and utilizes data in the storing block 322 as the shared resource.

Therefore, the procedure of switching to the new owner human-machine interface can be automatically performed and switched in according to the status of each owner human-machine interface, so as to maintain the uninterrupted sharing mechanism. In other words, the multi-human-machine interface system can continuously provide the function that one human-machine interface is managed by another human-machine interface.

The multi-human-machine interface system of the present disclosure is not limited to the structure as shown in FIG. 2. In the multi-human-machine interface system of the present disclosure, every human-machine interface can be coupled with 1 to N other human-machine interfaces and coupled with 0 to M operating devices, wherein N and M are positive integers. In addition, the multi-human-machine interface system at least includes one group, every group includes 1 to K human-machine interfaces to be the group member(s) and sets at least one human-machine interface to provide its own storing block to be the shared memory resource of the group, wherein K is a positive integer. In other words, based on real practical situation, the layers and the device amounts of the multi-human-machine interface system may be different.

In one of the exemplary embodiments, the storing blocks 212, 222 can be, for example but not limited to, random access memory (RAM), flash memory, read only memory (ROM), hard disk drive (HDD, solid state drive (SSD), optical storage, or a combination of the above components.

Please refer back to FIG. 1. In another embodiment, the computation device of the present disclosure executes the editing software 100 to set the common device resource 120 of the multiple human-machine interfaces of same group. In some embodiments, the computation device executes the editing software 100 to edit the protocol configuration and the channel configuration between multiple operating devices and multiple human-machine interfaces in same group, as well as the register information of the multiple operating devices, so as to generate the common device resource 120. Taking the first human-machine interface 162 to be connected to the first operating device 122 and the second human-machine interface 164 to be connected to the second operating device 124 as an example, the common device resource 120 at least includes a memory space of the first operating device 122 and a memory space of the second operating device 124, wherein the memory space of the first operating device 122 records first operating device data and the memory space of the second operating device 124 records second operating device data.

As discussed above, the first human-machine interface 162 is connected with the first operating device 122, so the first human-machine interface 162 can directly access the first operating device data through the first operating device 122; the second human-machine interface 164 is connected with the second operating device 124, so the second human-machine interface 164 can directly access the second operating device data through the second operating device 124. Also, in the present disclosure, the first human-machine interface 162 can access the second operating device data through the common device resource 120, and the second human-machine interface 164 can access the first operating device data through the common device resource 120.

In this embodiment, the common device resource 120 is shared to other group members in same group by the human-machine interface that is connected with the device, therefore, the owner of the memory space of the first operating device 122 that sharing the first operating device data is the first human-machine interface 162 that is connected with the first operating device 122; the owner of the memory space of the second operating device 124 that sharing the second operating device data is the second human-machine interface 164 that is connected with the second operating device 124, and so on.

When the first operating device 122 is changed from being coupled with the first human-machine interface 162 to being coupled with the second human-machine interface 164, the first human-machine interface 162 cannot access the first operating device data directly through the first operating device 122. In this embodiment, the first human-machine interface 162 needs to read the common device resource 120 to access the first operating device data through the group member in the same group. Because now the first operating device 122 is coupled with the second human-machine interface 164, so the second human-machine interface 164 can assist the first human-machine interface 162 that is in the same group to access the first operating device data of the first operating device 122.

For example, the first human-machine interface 162 is originally connected with the first operating device 122 and a first tag is one variable of the first operating device 122. At that time, the first human-machine interface 162 can directly access the first operating device 122 to access the first tag. Because the first tag is a variable of the first operating device 122, is can be used to generate the common device resource 120 while using the editing software 100 to edit the group project. Therefore, when the user changes the first operating device 122 to be coupled with the second human-machine interface 164, the first human-machine interface 162 is aware that it is no longer the owner of the first operating device 122. When accessing the first tag is required, the first human-machine interface 162 performs the access through other group members of the same group based on the common device resource 120. At that time, the second human-machine interface 164 can assist the first human-machine interface 162 to access the first tag of the first operating device 122. Besides, because the access is performed through the common device resource 120, the aforementioned shared memory block is unnecessary.

General speaking, when the user uses the editing software 100 to edit the project of each human-machine interface, the connection approach and the parameters of each operating device are known information, therefore, any human-machine interface in the same group knows the common device resource 120, such as having the Ethernet interface for accessing through Modbus/TCP or having the RS485 interface, etc. When editing the project, a human-machine interface connected with an operating device (such as the first human-machine interface) can directly set the resource of this operating device, such as the IP or the RS485’s serial port parameters, etc. During the execution under the runtime environment, if there is a need to change an operating device to connect to another human-machine interface (such as the second human-machine interface), the second human-machine interface can provide a setting interface to directly input and modify the parameters. However, other human-machine interfaces in the group (such as the third human-machine interface or the fourth human-machine interface, etc.) access the group, so they do not have to know how the connection parameters of this operating device are set.

To be more specifically, the resource of the operating device is usually known information, such as the type and range of the register. However, the resource of the operating device can be changed after running, for example, a PLC device can be changed and then “application.motion.info” is created. If the activity of the human-machine interface (such as the first human-machine interface) connected with the operating device (such as the first operating device) is only proxy access, when any human-machine interface in the group wants to access the information of the first operating device, the first human-machine interface belonging to the owner will only send and respond to the information, and will not be affected by resource changes in the operating device. However, if the first human-machine interface is added with a range limitation (i.e. it can only access the current device information of the project being edited), when the resource of the operating device changes, the first human-machine interface must re-download the project information to accept the added or changed access range.

In sum, the multi-human-machine interface system and resource sharing method of the present disclosure, through the resource sharing mechanism, eliminate the need for the users to manually change the settings and configuration relationships of the human-machine interfaces one-by-one. Under the multi-human-machine interface system architecture, regardless of physically adding, removing, or changing any device or human-machine interface, it can autonomously adapt to device changes and automatically complete the management operations to the human-machine interfaces. Therefore, the multi-human-machine interface system and resource sharing method of the present disclosure may greatly simplify the tedious process of traditional human-machine interface system that requiring manual modification of settings in response to physical device changes.

As the skilled person will appreciate, various changes and modifications can be made to the described embodiment. It is intended to include all such variations, modifications and equivalents which fall within the scope of the present disclosure, as defined in the accompanying claims.

What is claimed is:

1. A multi-human-machine interface system, comprising:
multiple human-machine interfaces, comprising:
a first human-machine interface;
a second human-machine interface; and
a computation device, coupled with the first human-machine interface and the second human-machine interface, configured to execute an editing software to set a shared memory block of the first human-machine interface and the second human-machine interface;
wherein the editing software is configured to perform a memory sharing operation for the first human-machine interface and the second human-machine interface through the shared memory block, wherein the shared memory block is configured with a virtual address space respectively mapped to a first memory of the first human-machine interface and a second memory of the second human-machine interface;
wherein the first human-machine interface is configured to access the first memory or the second memory being mapped to the virtual address space through the shared memory block, and the second human-machine interface is configured to access the first memory or the second memory being mapped to the virtual address space through the shared memory block.

2. The multi-human-machine interface system of claim 1, wherein the editing software is configured to edit the multiple human-machine interfaces to be multiple group members of same group project, edit multiple variables of the group project, edit the group project to set the shared memory block and respectively configure the shared memory block to each of the group members, and generate an execution program, a script, or a setting data and deploy the execution program, the script, or the setting data to the multiple group members of the group project, wherein the multiple human-machine interfaces operate the execution program, the script, or the setting data to execute under a runtime environment, wherein each of the variables is a common parameter of the multiple human-machine interfaces.

3. The multi-human-machine interface system of claim 2, wherein the multiple variables of the group project comprise at least one of system parameters of the multiple human-machine interfaces, memory addresses of the multiple human-machine interfaces, connection settings with all of the human-machine interfaces, screen parameters of the multiple human-machine interfaces, and tags of all of the human-machine interfaces.

4. The multi-human-machine interface system of claim 1, wherein when the first human-machine interface changes content of the first memory, the content of the first memory is synchronized to the second memory of the second human-machine interface through mapping of the virtual address space; when the second human-machine interface changes content of the second memory, the content of the second memory is synchronized to the first memory of the first human machine interface through mapping of the virtual address space.

5. The multi-human-machine interface system of claim 2, further comprising multiple operating devices, the multiple operating devices comprises a first operating device and a second operating device, wherein the first operating device is connected with the first human-machine interface and the second operating device is connected to the second human-machine interface.

6. The multi-human-machine interface system of claim 5, wherein the editing software is configured to set a common device resource of the first human-machine interface and the second human-machine interface, the common device resource comprises tags, communication setting information, and register information of the first operating device and the second operating device, wherein the first human-machine interface is configured to request the second human-machine interface in the group project to access device data of the second operating device based on the common device resource, and the second human-machine interface is configured to request the first human-machine interface in the group project to access device data of the first operating device based on the common device resource.

7. The multi-human-machine interface system of claim 2, wherein the shared memory block comprises multiple shared blocks, the multiple shared blocks comprises a first shared block and a second shared block, an owner of the first shared block is the first human-machine interface and an owner of the second shared block is the second human-machine interface, wherein each owner of each shared block respectively has an authority of changing each corresponding shared block and is configured to trigger the multiple human-machine interfaces being a non-owner to perform a synchronization activity to each of the shared blocks.

8. The multi-human-machine interface system of claim 2, wherein the second human-machine interface is configured to send a global change request to the first human-machine interface which is the owner of the shared memory block when the second human-machine interface wants to write update data to the second memory that is mapped to the shared memory block, the first human-machine interface is configured to change content of the shared memory block based on the update data according to the global change request and broadcast the update data to each of the group members in the group project through sending a global notification, thus each of the group members stores the update data to individual local storing block to maintain a synchronization with the shared memory block.

9. The multi-human-machine interface system of claim 2, wherein one of the multiple group members is configured to execute group broadcasting to send a switch-over request to the multiple human-machine interfaces of the group project, the switch-over request is used to select, from the multiple human-machine interfaces, a new owner human-machine interface for the shared memory block and enable the new owner human-machine interface to have the authority of changing and managing the shared memory block.

10. The multi-human-machine interface system of claim 9, wherein the new owner human-machine interface is determined based on a negotiation number of each of the multiple human-machine interfaces.

11. The multi-human-machine interface system of claim 10, wherein the negotiation number is determined by random numbers, pre-determined priority values, and an execution performance of the multiple human-machine interfaces.

12. A multi-human-machine interface system, comprising:
multiple human-machine interfaces, comprising:
a first human-machine interface, connected with a first operating device;
a second human-machine interface, connected with a second operating device; and
a computation device, coupled with the first human-machine interface and the second human-machine interface and configured to execute an editing software to set a common device resource of the first human-machine interface and the second human-machine interface;
wherein the common device resource is configured to comprise a memory space of the first operating device and a memory space of the second operating device, wherein the memory space of the first operating device records first operating device data and the memory space of the second operating device records second operating device data;
wherein the first human-machine interface accesses the first operating device data through the first operating device, and access the second operating device data through the common device resource;
wherein the second human-machine interface accesses the second operating device data through the second operating device, and access the first operating device data through the common device resource.

13. The multi-human-machine interface system of claim 12, wherein the editing software is configured to edit the multiple human-machine interfaces to be multiple group members of same group project, edit multiple variables of the group project, and generate an execution program, a script, or a setting data and deploy the execution program, the script, or the setting data to the multiple group members of the group project, wherein the multiple human-machine interfaces operate the execution program, the script, or the setting data to execute under a runtime environment, wherein each of the variables is a common parameter of the multiple human-machine interfaces.

14. The multi-human-machine interface system of claim 12, wherein an owner of the memory space of the first operating device is the first human-machine interface and an owner of the memory space of the second operating device is the second human-machine interface, wherein the first human-machine interface has an authority of changing and managing the memory space of the first operating device and the second human-machine interface has an authority of changing and managing the memory space of the second operating device.

15. The multi-human-machine interface system of claim 13,
wherein the editing software is configured to edit protocol configurations and channel configurations between the first operating device and the second operating device and the multiple human-machine interfaces, and edit register information of the first operating device and the second operating device, to generate the common device resource; and
the first human-machine interface is configured to directly access the first operating device data through the first operating device being connected;
wherein when the first operating device is changed from being coupled with the first human-machine interface to being coupled with the second human-machine interface, the first human-machine interface is configured to read the common device resource to obtain the first operating device data of the first operating device through the second human-machine interface in the group project.

16. The multi-human-machine interface system of claim 13, wherein the common device resource comprises a device configuration, a device resource, and a tag address of the multiple group members in the group project, wherein the device configuration comprises connection port information, and the device resource comprises at least one of current and voltage.
